(19) United States
(12) Patent Application Publication
(10) Pub. No.: US 2012/0036466 A1
(43) Pub. Date: Feb. 9, 2012

(54) SYSTEMS AND METHODS FOR LARGE DATA SET NAVIGATION ON A MOBILE DEVICE

(75) Inventors: Medhi Venon, Whitefish Bay, WI (US); Sukhdeep Gill, London (CA); Christopher Janicki, Sleepy Hollow, IL (US)

(73) Assignee: GENERAL ELECTRIC COMPANY, Schenectady, NY (US)

(21) Appl. No.: 12/850,379

(22) Filed: Aug. 4, 2010

(51) Int. Cl. G06F 3/048; G06F 3/033

(52) U.S. Cl. 715/772; 715/838; 715/800; 715/863; 715/810

(57) ABSTRACT

Example systems and methods provide navigation and review of images within a large data set via a handheld or other mobile device. A computer-implemented method includes providing a clinical data set divided into a plurality of portions. Each portion is associated with a graphical representation and includes a plurality of sub-portions. The graphical representation for each portion is displayed to a user such that the plurality of portions can be viewed on a user interface of the device. User navigation is facilitated at various levels of granularity among the plurality of portions via the user interface. User access is allowed to one or more sub-portions within a portion to locate an item of clinical data within a sub-portion. User selection of an item of clinical data within a sub-portion is enabled for viewing via the user interface. A selected item of clinical data is loaded for viewing via the user interface.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### FIELD

The present generally relates to access and review of images from a large data set. More particularly, the present invention relates to access and review of images from a large data set via a handheld or other mobile device.

### BACKGROUND

With modern imaging scanners and acquisition protocols of multi-slice data, an amount of information available for each exam has been exponentially increasing over the last decade. Radiologists and other clinician can access exams with over 100 images or even 1000 images for an exam. As new acquisition sequences and improved detectors are developed, an amount of available data to be reviewed is likely to continue to increase.

### BRIEF SUMMARY

Certain embodiments of the present invention provide systems and methods for navigation and review of item of clinical data (e.g., images, reports, records, and/or other clinical documents) within a large data set via a handheld or other mobile device.

Certain examples provide a computer-implemented method for navigating images in a large data set using a mobile device having a user interface. The method includes providing a clinical data set for user view. The clinical data set is divided into a plurality of portions. Each portion is associated with a graphical representation and including a plurality of sub-portions. The graphical representation for each portion is displayed to a user such that the plurality of portions can be viewed on a user interface of a mobile device according to their graphical representations without downloading content of each portion to the mobile device. The method includes facilitating user navigation at various levels of granularity among the plurality of portions via the user interface of the mobile device. The method includes allowing user access to one or more sub-portions within a portion to locate an item of clinical data within a sub-portion. The method includes enabling user selection of an item of clinical data within a sub-portion for viewing via the user interface of the mobile device. The method includes loading a selected item of clinical data for viewing via the user interface of the mobile device.

Certain examples provide a tangible computer-readable storage medium having a set of instructions stored thereon which, when executed, instruct a processor to implement a method for navigating clinical content in a large data set using a mobile device having a user interface. The method includes providing a clinical data set for user view. The clinical data set is divided into a plurality of portions. Each portion is associated with a graphical representation and including a plurality of sub-portions. The graphical representation for each portion is displayed to a user such that the plurality of portions can be viewed on a user interface of a mobile device according to their graphical representations without downloading content of each portion to the mobile device. The method includes facilitating user navigation at various levels of granularity among the plurality of portions via the user interface of the mobile device. The method includes allowing user access to one or more sub-portions within a portion to locate an item of clinical data within a sub-portion. The method includes enabling user selection of an item of clinical data within a sub-portion for viewing via the user interface of the mobile device. The method includes loading a selected item of clinical data for viewing via the user interface of the mobile device.

Certain examples provide an image viewing and navigation system. The system includes a handheld device including a memory, a processor, a user interface including a display, and a communication interface. The handheld device is configured to communicate with an external data source to retrieve and display image data from an image data set. The handheld device facilitates user navigation and review of images from the image data set via the user interface. The processor executes instructions saved on the memory to provide access to an image data set stored at the external data source. The image data set is divided into a plurality of portions. Each portion is associated with a graphical representation and including a plurality of sub-portions. The graphical representation for each portion is displayed to a user such that the image data set divided into the plurality of portions can be viewed via the user interface according to their graphical representations without downloading content of each portion to the mobile device. User navigation is facilitated at various levels of granularity among the plurality of portions via the user interface. User access to one or more sub-portions within a portion is allowed to locate an image within a sub-portion. User selection of an image within a sub-portion is enabled for viewing via the user interface. A selected image is loaded from the external data source via the communication interface for viewing via the user interface.

### BRIEF DESCRIPTION OF SEVERAL VIEWS OF THE DRAWINGS

FIG. 1 depicts an example large data set divided into data chunks or sections for user access and review.

FIG. 2 illustrates an example navigation or “zooming” to a next level of data chunks in a large image data set.

FIG. 3 illustrates an example navigation to a lowest level of detail available in an image data map including individual objects that define a data chunk.

FIG. 4 depicts a flow diagram for an example method for large dataset access and review.

FIGS. 5-16 illustrate example views of representation and navigation within a large image dataset on a viewing device.

FIG. 17 depicts an example clinical enterprise system for use with systems, apparatus, and methods described herein.

FIG. 18 is a block diagram of an example processor system that may be used to implement the systems, apparatus and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Certain examples provide systems and methods to accommodate organization and viewing of large data sets on a mobile device. Using a mobile device equipped with a capability for wireless communication with a remote provider, computerized reading of diagnostic images is facilitated. Additionally, other computer or processor-based devices can be used to access and view a smaller subset of data from a large pool of data sets.

Certain examples address challenges involved with navigating through large data sets to quickly access desired data from the sets while minimizing end user wait time and data transfer time (which translates to minimizing bandwidth use, battery use of the mobile device, and costs of network communication on an end user's wireless data plan, for example).

With modern imaging scanners and acquisition protocols of multi-slices data, the amount of information available for each exam has been exponentially increasing over the last decade. It is not uncommon to access exams with over 100 images or even 1000 images for an exam. As detectors continue to improve and new acquisition sequences are developed, the amount of data available should continue to increase. With wireless devices, especially GSM technology, even with the recent transfer speed improvements of 3G, WiMAX, and 4G, available bandwidth limits how fast the amount of data is retrieved. Frequently, end users do not need to access an entire data set but rather small subsets of the data to view and support fellow physician seeking feedback from their mobile device.

Certain disclosed systems and methods help enable fast user access to images and/or other clinical content sought for review while minimizing transfer time and downtime (e.g., time a user is waiting to access a desired image). Adaptive resolutions and streaming technologies have helped increase access to data from mobile Internet devices, but an increase in an amount of information available poses a challenge in providing fast access to desired data by users. Thus, certain examples described herein help provide easy, fast access to individual data in large data sets via a mobile device.

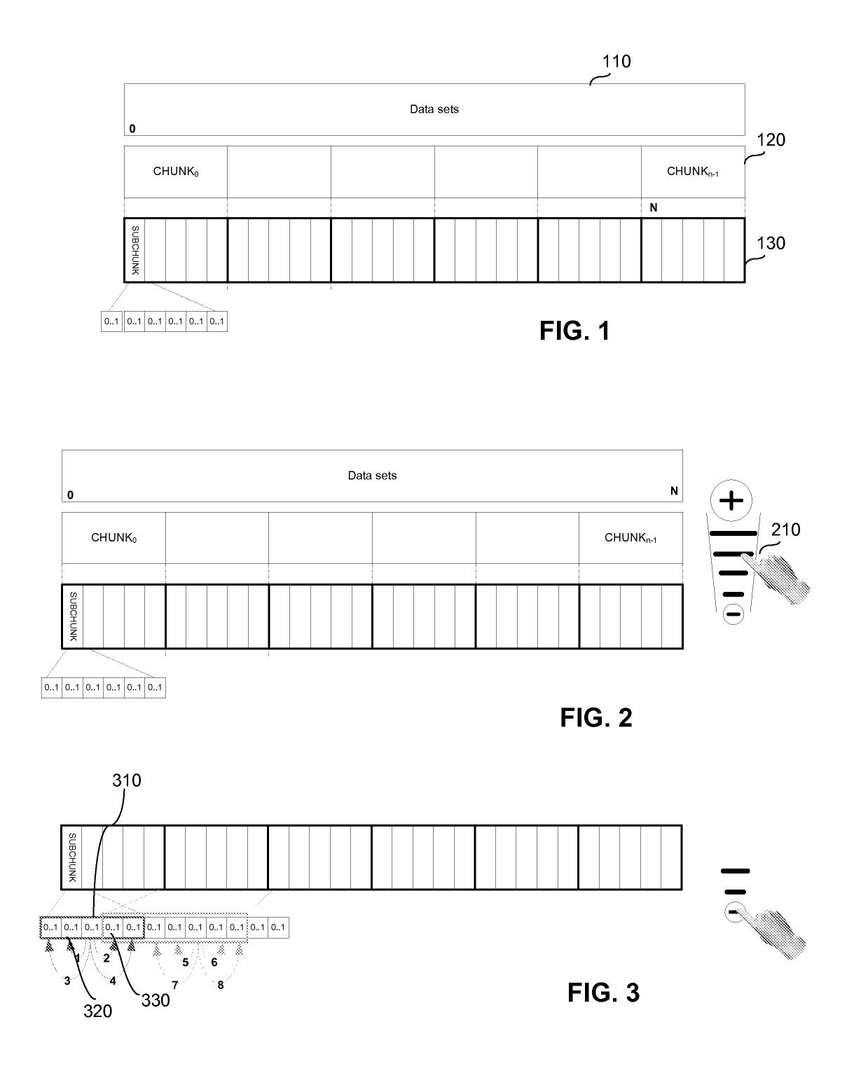

In certain examples, such as the example shown in FIG. 1, an original or complete data set 110 is divided or sliced into data chunks, portions, or sections 120, where each chunk 120 is defined as a percentage of the original data set. For example, each chunk 120 can be but not limited to every 10% of the data set. Each chunk 120 can be formed from one or more sub-chunks, sub-portions, or sub-sections 130. Each sub-chunk 130 includes a set of continuous data objects. One or many sets of data objects 130 (e.g., items of clinical data such as images, reports, records, and/or other electronic documents) can belong to one or more parent chunks 120.

Data can be indexed and then accessed as a user would zoom in on an area in a map. As the user zooms in to a particular area of data, the user has access to a next level of chunk data that is linked together. As the user zooms out and navigates to another section or chunk 120, the user gains access to a next level subset of data. Map-based zoom in and out navigation allows an efficient way for the user to navigate through the data map to find a particular subset.

When the user accesses a data viewer component and/or other component to navigate one or more data sets 110, an associated application requests software objects for each data chunk 120 represented by a key or representative image or portion of the chunk. The key or representative portion can be defined as but is not limited to a median data object of each section of the data map. Alternatively, the key object can be defined as a first, last, significant, or other object of the chunk 120.

When the user navigates to a particular chunk 120 of data, the sub-chunks 130 contained within the chunk 120 are loaded and displayed to the user. As illustrated, for example, in FIG. 2, navigation or “zooming” to the next level of chunks can be accomplished by a gesture 210, such as a screen swipe, sliding a user interface control widget, or other navigation technique. Additionally, a visual transition between the layers or levels of information detail can be represented by an animation or abrupt display of the next level of key objects, for example.

In certain examples, no limit is imposed on a number of levels or sections in the data map. The number of levels or sections is defined by the size of the original data set and how many key or significant data objects are to be displayed to the user per level of granularity.

As the user zooms in and navigates to the next section of data, the user can zoom in further or zoom out to view different levels of data granularity. Zooming refers to navigating between each level of data chunk (e.g., level of data granularity). A zoom out allows the user to move to higher level of a section of data in the data map, and a zoom in allows the user to move to the next or lower (e.g., more detailed) level of detail within the section.

Although certain examples described above are directed to navigating large consecutive sets of image data, certain examples facilitate navigation with respect to parent containers of medical exam image data sets. A study or exam may have multiple series of images, and the user may wish to quickly navigate between data sets. Using the navigation techniques and systems discussed herein, the user can “jump” between series and quickly dive into varying levels of granularity contained within each series based on portions and sub-portions of available data. Similarly, in image series navigation, a user can select a set of images to view within a selected series using a data map-based interface.

As illustrated, for example, in FIG. 3, when a user navigates to a lowest level of detail available in a data map, continuous individual objects that define a data chunk are transferred to the user's mobile device for access by the user. The logic and/or algorithm for loading these objects may be but not limited to consecutively, median loading, and/or other loading technique. A selected object 310 is loaded, followed by each object to the immediate left 320 and right 330 of the selected object that has not already been loaded on the mobile device. Then, the next object to the left and right of the selected object that has not already been loaded is loaded until an entire consecutive set of objects has been loaded on the user's mobile device.

At any time, the user can zoom out to select another region in the parent level of objects. If the user zooms out, the loading process can continue in the background when system resources are available to do so. In certain examples, a visual indication of the loading progress, such as a progress bar or slider control, is displayed to apprise the user of loading status.

In an example, a touchpad LCD display of a mobile device, such as an Apple iPhone™ is used to present a large of group of images and provide intuitive, easy access to the desired image or set of images for review.

In an example, the mobile device allows a user to use a two-finger zoom gesture to navigate between each level of image chunk. Using the two-finger zoom, a lower level of granularity in the group of images the user can access corresponds to a longer distance between the user's two fingers in the gesture. Conversely, a closer distance between the user's two fingers corresponds to a higher level of image groups to which the access would zoom.

In an example, when using a two-finger zoom gesture to access to a lowest level of a group of images, the user can use double tapping access to access the lowest group of image(s) linked to a particular image presented on the screen. The lowest group is represented with respect to a continuous set of images based on their index and/or the time. The highest group of image(s) is represented by the set of images represented as a group heading, likely the most significant image of an area represented.

In an example, the end user can select multiple images from various groups by tapping or otherwise highlighting the images. The user can navigate between levels to select non-continuous images. If each group of images is close enough, the user can use a swiping motion to the left or right to access a continuous group of images to perform the selection, for example.

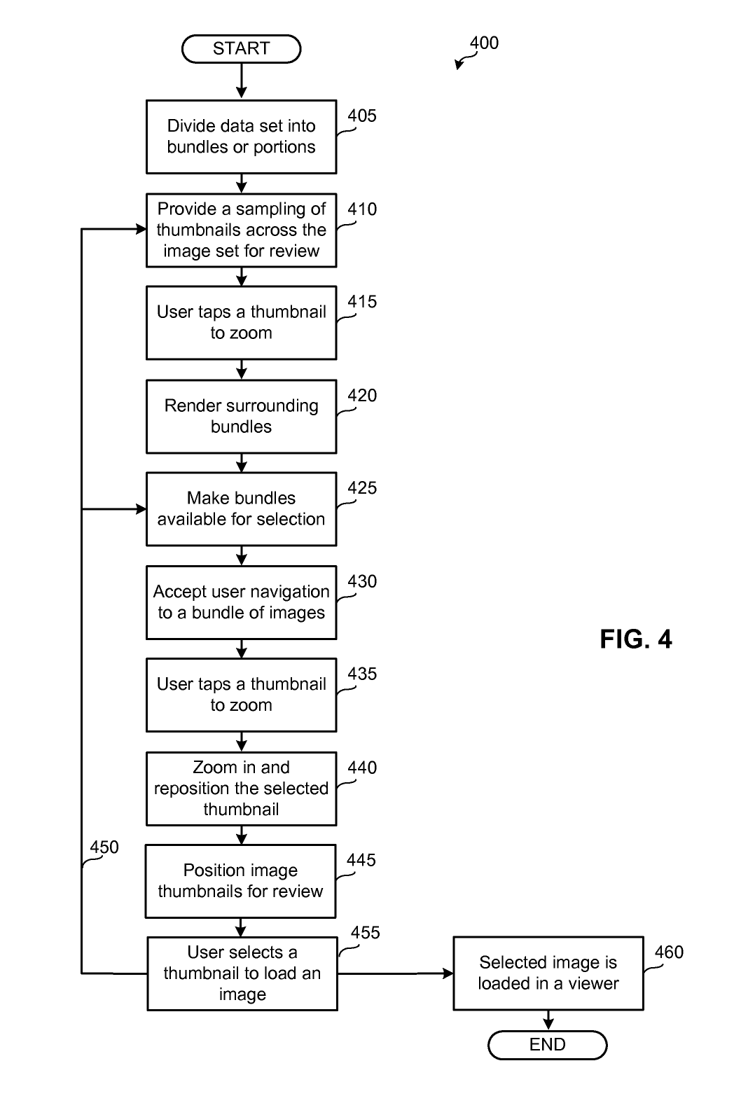

FIG. 4 depicts an example flow diagram representative of processes that can be implemented using, for example, computer readable instructions that can be used to facilitate reviewing of anatomical images and related clinical evidence. The example processes of FIG. 4 can be performed using a processor, a controller and/or any other suitable processing device. For example, the example processes of FIG. 4 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 4 can be implemented using coded instructions (e.g., computer readable instructions) stored on a non-transitory computer readable medium such as a flash memory, a read-only memory (ROM), a random-access memory (RAM), a CD, a DVD, a Blu-ray, a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 4 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 4 can be implemented manually or as any combination(s) of any of the foregoing techniques, for example, any combination of firmware, software, discrete logic and/or hardware. Further, although the example processes of FIG. 4 are described with reference to the flow diagram of FIG. 4, other methods of implementing the processes of FIG. 4 may be employed. For example, the order of execution of the blocks can be changed, and/or some of the blocks described may be changed, eliminated, sub-divided, or combined. Additionally, any or all of the example processes of FIG. 4 can be performed sequentially and/or in parallel by, for example, separate processing threads, processors, devices, discrete logic, circuits, etc.

FIG. 4 depicts a flow diagram for an example method 400 for large dataset access and review. At 405, a large image set is divided into image bundles or portions. Each bundle includes a percentage of images across the entire set.

At 410, a user can scan a sampling of thumbnails across the image set to find a point in the series that he or she wishes to view. At 415, tapping an image thumbnail/block (and/or using a pinch gesture) zooms in on the selected bundle. At 420, blocks surrounding the selected block are also rendered. At 425, the selected and surrounding bundles are available for selection in a display grid.

At 430, user navigation (e.g., via swiping a finger up, down left, or right) takes the user to a next or previous bundle of images. At 435, a user can again tap on a thumbnail or block. At 440, the view zooms in and repositions the selected block in the interface. At 445, at the lowest level of detail, there are no more blocks or bundles to select. Rather, thumbnails or icons representing individual images are positioned for user view and selection.

At 450, a user can zoom out again using gesture-based and/or other navigation. At 455, tapping an image thumbnail at the lowest level of zoom begins a loading of images surrounding the selected image. At 460, the selected image is loaded in the viewer.

As described herein, the method 400 can be implemented using a handheld and/or other mobile device in one or more combinations of hardware, software, and/or firmware, for example. The method 400 can operate with the mobile device in conjunction with one or more external systems (e.g., data sources, healthcare information systems (RIS, PACS, CVIS, HIS, etc.), archives, imaging modalities, etc.). One or more components of the method 400 can be reordered, eliminated, and/or repeated based on a particular implementation, for example.

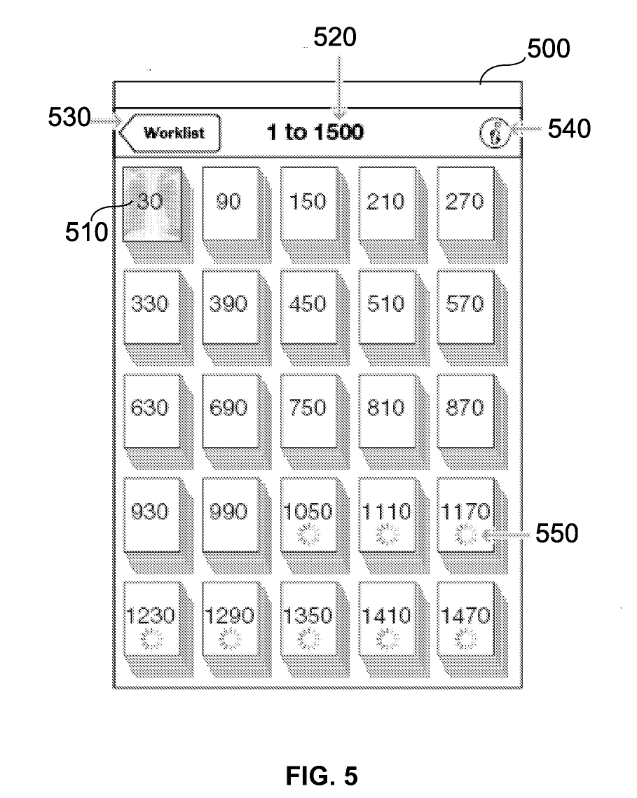

FIG. 5 illustrates an example view 500 of a large dataset (e.g., a large image dataset). The dataset 500 is divided into twenty-five image “bundles” 510. Each bundle 510 includes a percentage of images from the entire data set 500. In the example of FIG. 5, each bundle 510 includes sixty images. The height of the bundle 510 visually indicates a number of images in the bundle. The size of the thumbnail or other icon representing the bundle 510 indicates a level of zoom. In some examples, a thumbnail image taken from the bundle (e.g., taken from the middle of bundle) is displayed on top of the bundle 510.

The view 500 can also include an alphanumeric indicator 520 of a total number of images in the data set. A worklist button or other icon 530 provides a link back to a clinician's worklist, for example. A thumbnail settings button or other icon 540 allows the user to view (and, in some examples, modify) the image thumbnail settings for the view 500, such as size, zoom factor, etc. In some examples, an activity indicator 550 is displayed in conjunction with an image bundle, if applicable, while thumbnail loading and/or other processing activity occurs. The indicator 550 conveys to the user that additional information (e.g., a thumbnail image) will be forthcoming, for example.

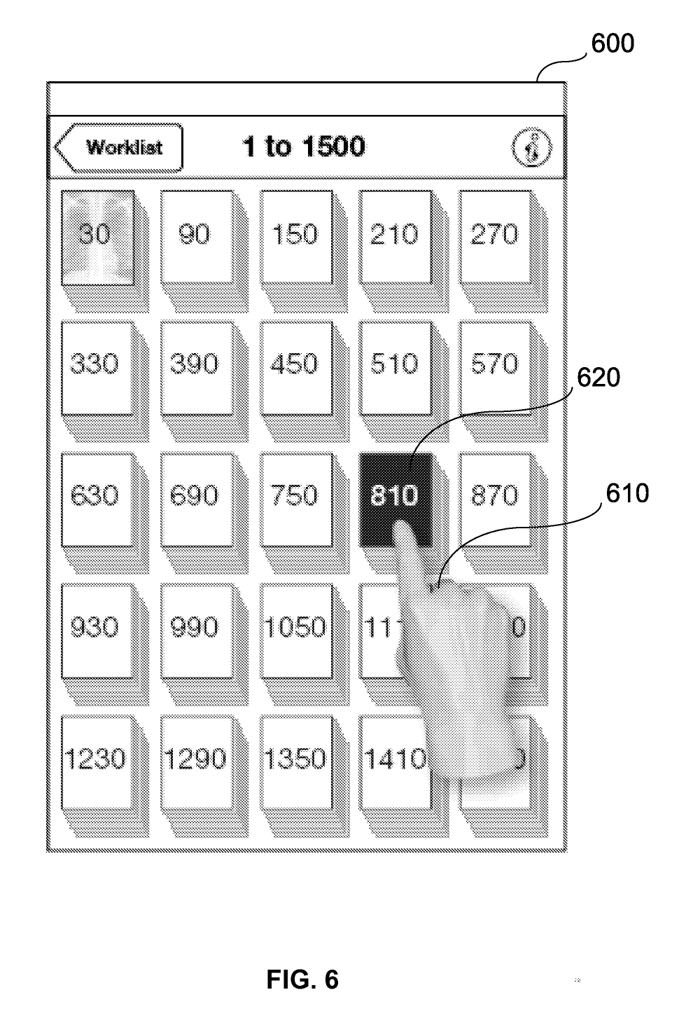

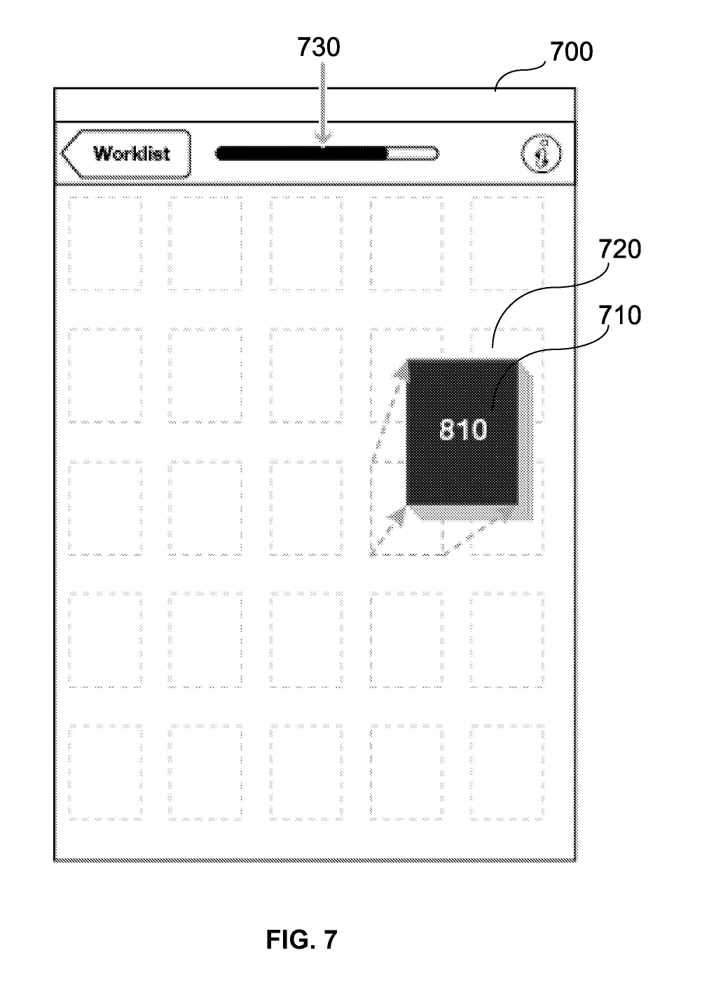

FIG. 6 illustrates an example view 600 of a large image dataset. As depicted in FIG. 6, a user can scan a sampling of thumbnails across the image set to find a point in the series that he or she wishes to view. Tapping 610 an image thumbnail/block representing a bundle 620 (and/or using a pinch gesture) zooms in on the selected bundle 620. FIG. 7 depicts a view 700 in which a user has tapped a bundle 710 to zoom in on the bundle 710. The size of the selected bundle 710 increases, while the surrounding bundles 720 fade out, for example. In some examples, if applicable, a progress bar 730 is displayed to alert the user as to the viewer's progress when zooming in on the bundle 710

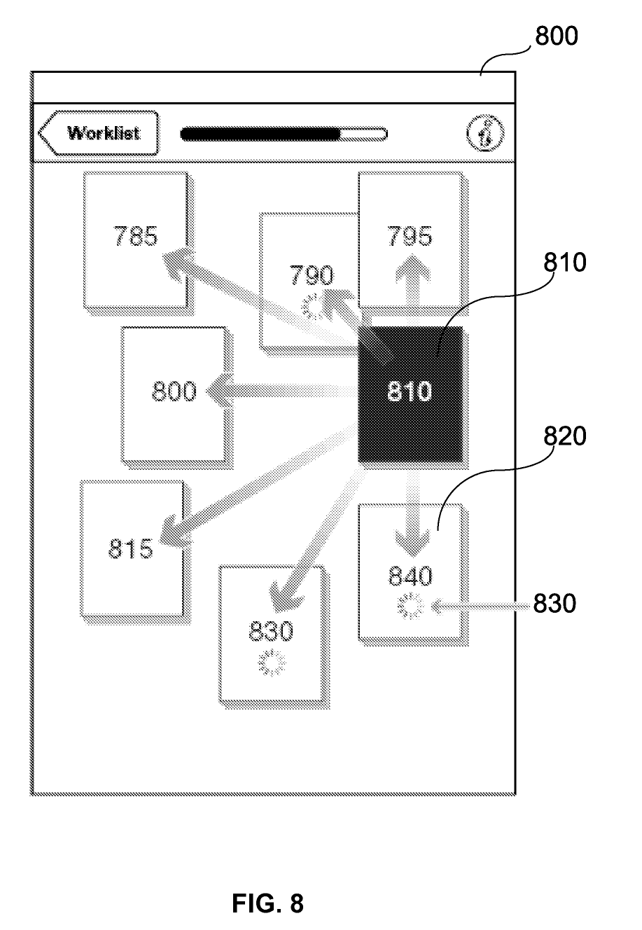

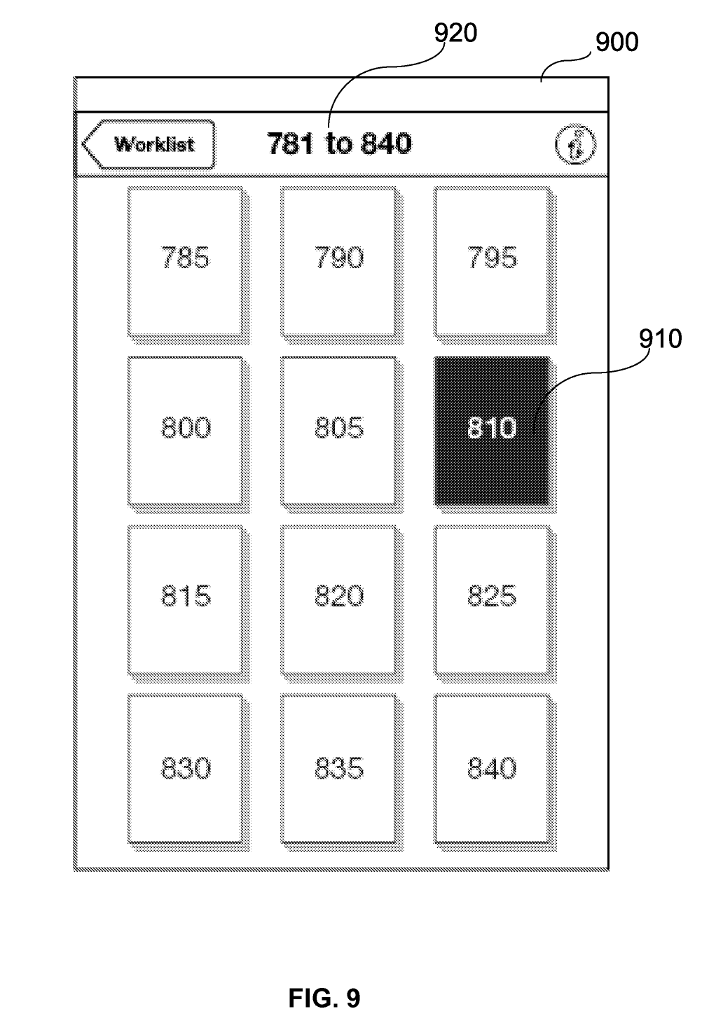

As shown, for example, in FIG. 8, additional bundles 820 that are subsets of the images in a current selection set 810 are displayed in conjunction with a selected bundle 810 to be zoomed. In the example 800 illustrated in FIG. 8, the additional bundles 820 animate out from behind the selection set 810 as if they were being dealt from a deck of cards. In some examples, an activity indicator 830 appears, if applicable, while a thumbnail loads. As shown in the example view 900 of FIG. 9, each image bundle 910 comes to rest in a grid pattern. A zoom level is visually represented by a size of the thumbnail and a height of a bundle 910. In the example of FIG. 9, the bundle height is five images. An indicator 920 provides a total number of images in the zoomed set.

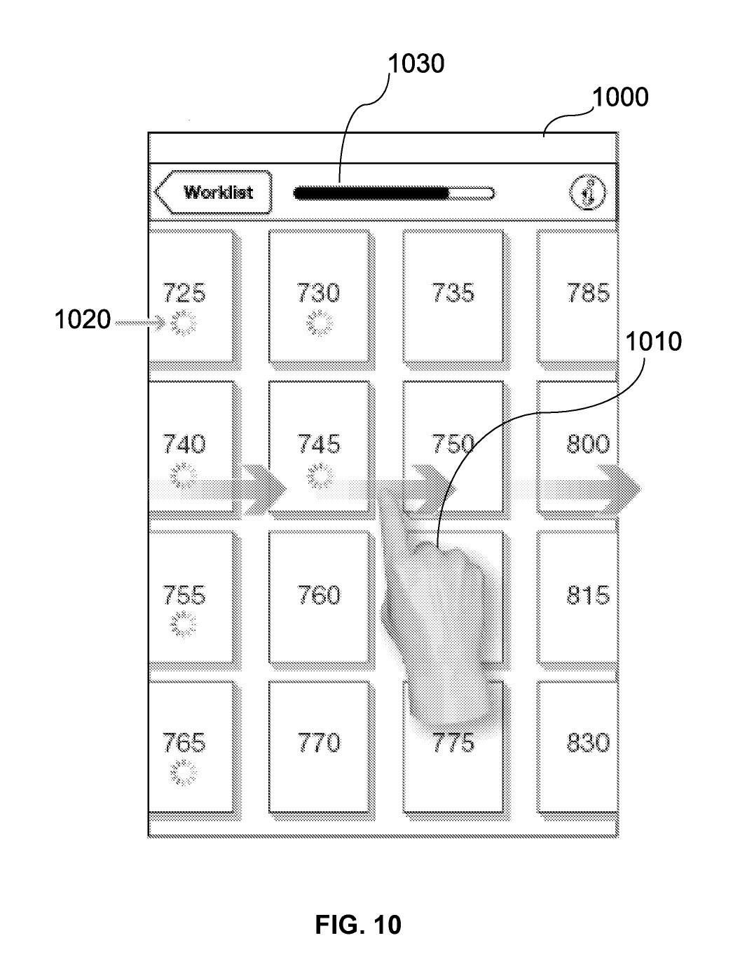

FIG. 10 depicts an example navigation view 1000 within the image data subset. Within the view 1000, swiping 1010 up, down, left and/or right (as shown in FIG. 10), at lower zoom levels, takes the user to the next (or previous) bundle of images. In some examples, an activity indicator 1020 and/or progress bar 1030 appears, if applicable, while a thumbnail and/or other associated information loads.

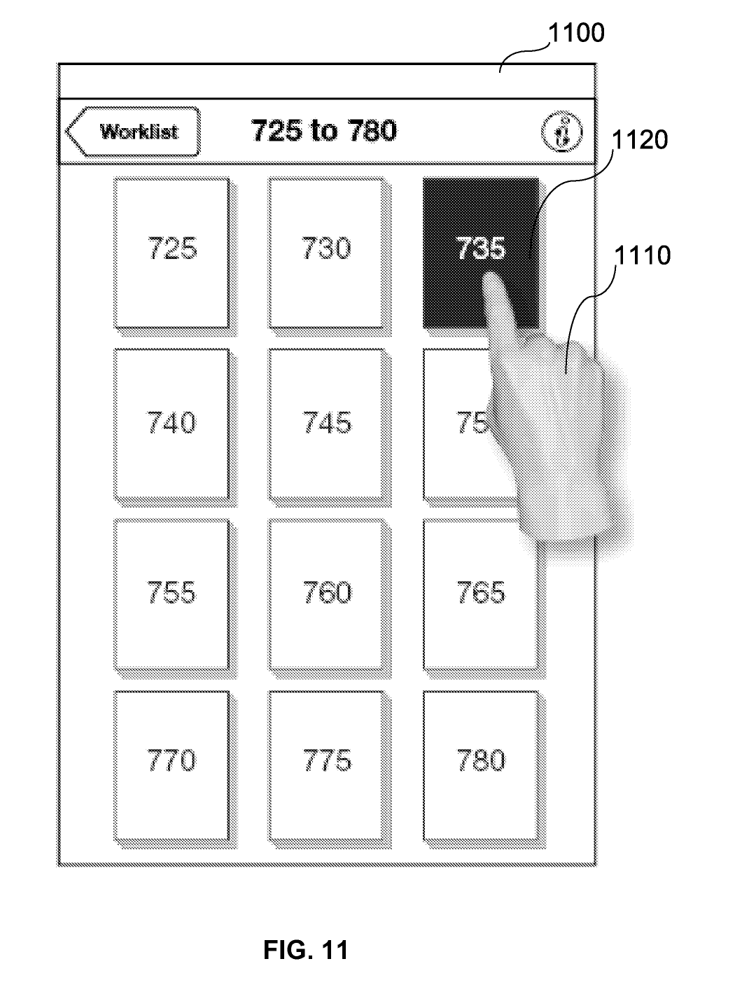

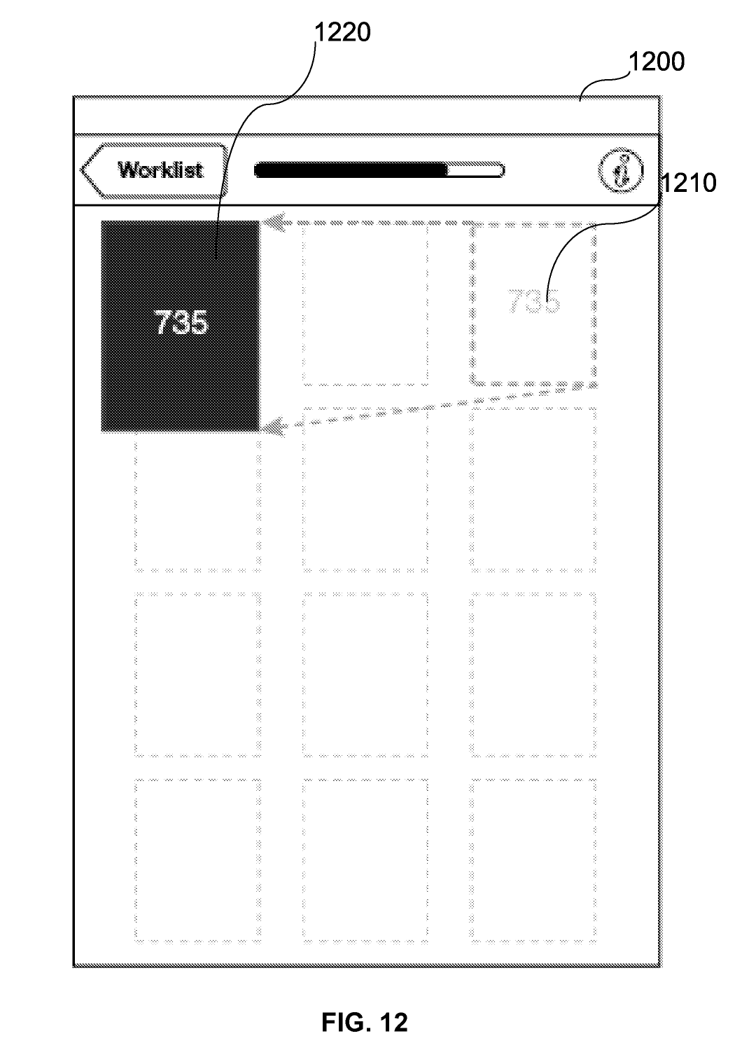

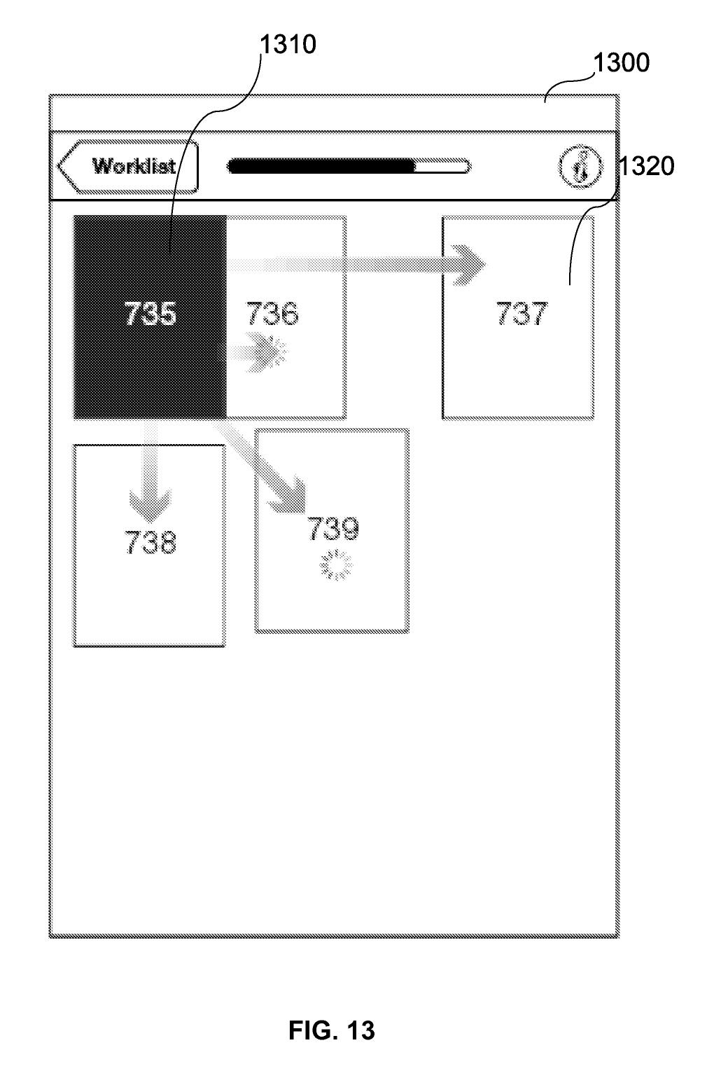

As shown, for example, in a view 1100 of FIG. 11, tapping 1110 on a thumbnail or block 1120 (or using a pinch gesture) selects a bundle or block 1120 for zooming. FIG. 12 illustrates a view 1200 in which a selected bundle or block 1210 is zoomed and repositioned 1220 in the view 1200. FIG. 13 depicts a view 1300 in which images 1320 within the selected bundle 1310 are “dealt out” from behind the selected image 1310 and onto the view 1300. At the lowest level of detail, there are no more blocks or bundles to select. Rather, thumbnails or icons representing individual images are positioned for user view and selection.

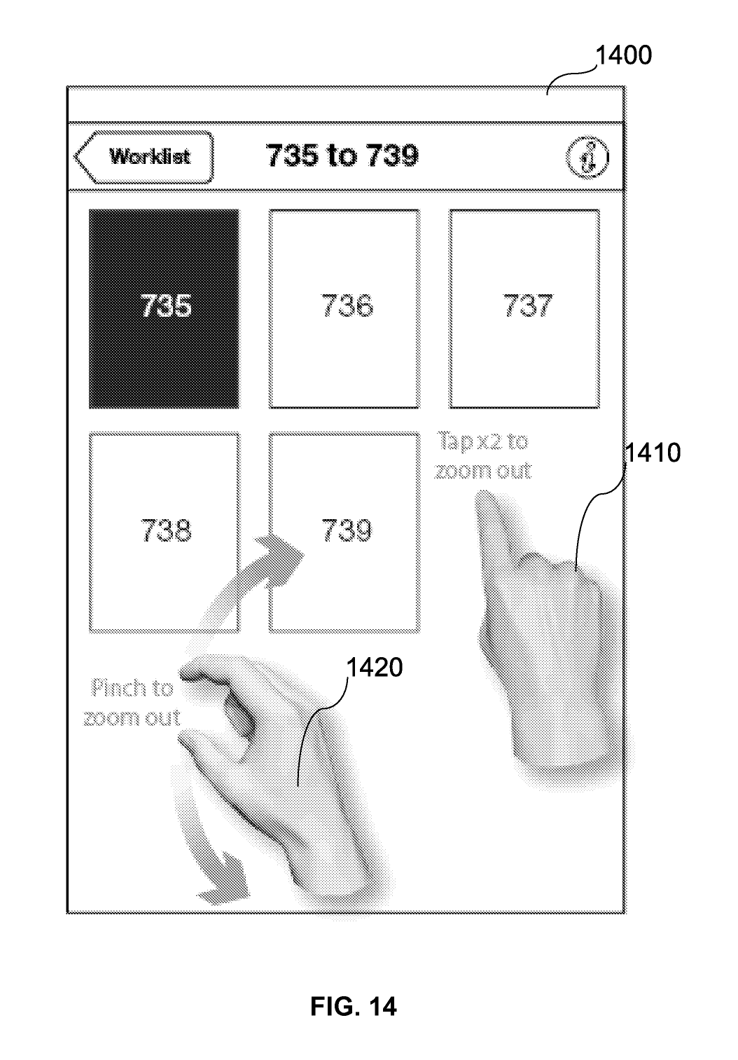

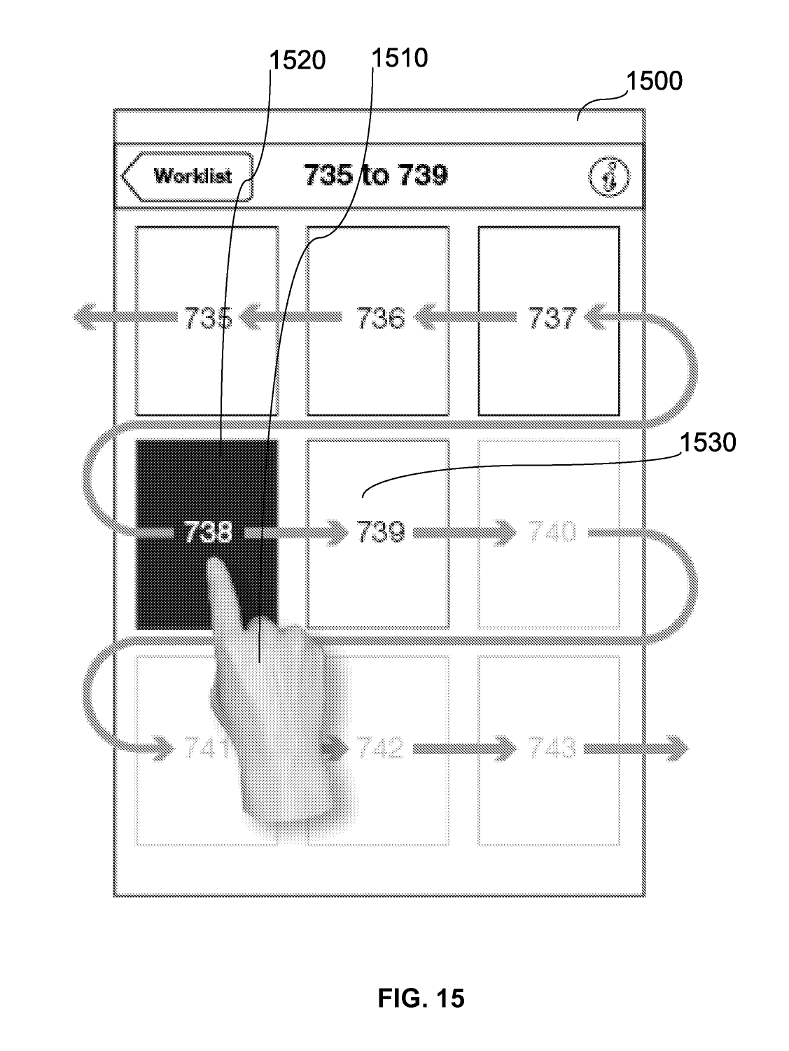

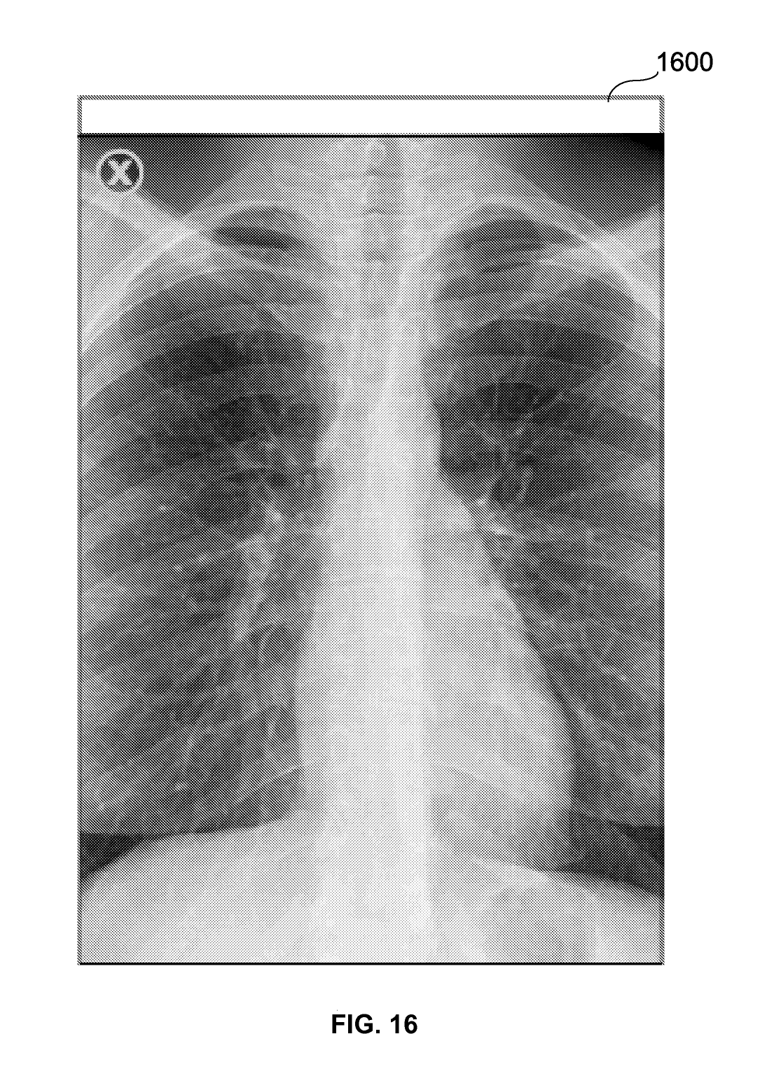

As illustrated, for example, in FIG. 14, a user can zoom out again using gesture-based and/or other navigation. For example, the user can double tap 1410 and/or pinch 1420 to zoom out. As shown in a view 1500 of FIG. 15, tapping 1510 an image 1520 thumbnail at the lowest level of zoom begins a loading of images 1530 surrounding the selected image 1520 and a launching of the selected image 1520 in a viewer. The example view 1500 illustrates a loading of images forward and backward from the selected image 1520. FIG. 16 illustrates a selected image is loaded in a viewer 1600.

Images included in a data set and its bundles can include two dimensional and/or three dimensional images from a variety of modalities (e.g., computed tomography (CT), digital radiography (DR), magnetic resonance (MR), ultrasound, positron emission tomography (PET), and/or nuclear imaging). The images can be retrieved from one or more sources. Images can be stored locally on a viewing device in a compressed and/or uncompressed form. Images can be stored remote from the viewing device and downloaded to the viewing device, such as according to bundle(s) retrieved for viewing by a user. That is, one or more subsets of a large image data set can be transferring to the viewing device as a bundle or subset of images is selected for zooming and/or viewing by the user.

In certain examples, three dimensional (3D) compression can be used to generate thick slabs from thin slices to more effectively navigate through a large image series. 3D viewing allows two dimensional (2D) slice by slice viewing as well as zoom through slices and random access via 3D. Using 3D loss-less multi-resolution image compression, multiple thin slices can be used to generate a slab or thick slice. In an example, axial decoding, spatial decoding and wavelet transforms are used for progressive decomposition of a thick slab to provide detail to the user. Techniques such as Huffman coding, position coding, and the like can be used. By directly decoding a compressed bit-stream into reformatted image(s) using 3D differential pulse code modulation (3D DPCM), less delay is introduced than with decoding and multi-planar reconstruction (MPR). Using 3D DPCM, a stack of 2D slices is considered as a 3D volume for compression, encoding, and decoding. Applying a transform/prediction to the image data allows for energy compaction and entropy coding provides statistical redundancy removal to reconstruct an image.

In certain embodiments, mobile devices, such as but not limited to smart phones, ultra mobile and compact notebook computers, personal digital assistants, etc., offer many applications aside from phone functions. Certain embodiments allow clinical end users to enhance their collaboration with their colleagues, patients, and hospital enterprise via the mobile device.

By integrating enterprise functions for mobile devices, such as but not limited to a directory, calendar, geographic location, phone services, text messages, email services, etc., with clinical information from various clinical sources, such as but not limited to PACS, HIS, RIS, etc., end users can access patient centric information and enable real-time or substantially real-time collaboration with other end users to collaborate on a specific patient case. The collaboration allows information sharing and recording using multiple media services in real-time or substantially real-time.

In certain examples, a mobile (e.g., handheld) device allows a user to display and interact with medical content stored on one or more clinical systems via the mobile or handheld device (such as an iPad™, iPhone™, Blackberry™, etc.). A user can manipulate content, access different content, and collaborate with other users to analyze and report on exams and other medical content. In some examples, a change in device orientation and/or position results in a change in device mode and set of available tools without closing or losing the patient context and previous screen(s) of patient information. Images can be manipulated, annotated, highlighted, and measured via the device. Enterprise functionality and real-time collaboration are provided such that the user can collaborate on a document in real time with other users as well as access content from systems such as a RIS, PACS, EMR, etc., and make changes via the handheld device.

The handheld device can display and interact with medical content via a plurality of modes. Each mode includes different content and associated tools. Each of the plurality of modes is accessible based on a change in orientation and/or position of the device while maintaining a patient context across modes. The handheld device also includes medical content analysis capability for display, manipulation, and annotation of medical content and real-time sharing of the content for user collaboration using multi-touch control by the user. The handheld device communicates with one or more clinical systems to access and modify information from the one or more clinical systems in substantially real-time.

The handheld device can be used to facilitate user workflow. For example, the handheld device uses an accelerometer and/or global positioning sensor and/or other positional/motion indicator to allow a user to navigate through different screens of patient content and functionality. Using gestures, such as finger touching, pinching, swiping, etc., on or near the display surface can facilitate navigation through and viewing of image(s) in a large image dataset. In some examples, multi-touch capability is provided to manipulate and modify content. Via the handheld device, a user can input and/or manipulate without adding external input devices.

In certain examples, the handheld device provides enhance resetability for the user. For example, the device can undo, erase, and/or reset end user changes to default setting by tracking a device's position and/or orientation and responding to changes to the position/orientation. The device can undo and restart without additional user interface control input. The device can adjust a threshold parameter through user feedback, for example (e.g., a current setting may be too sensitive to normal movement of the device when carried or held by a user).

Certain examples integrate enterprise functions into a mobile device. For example, functionality such as a directory, calendar, geographic location, phone services, text message, email, etc., can be provided via the mobile device. Clinical information from various sources such as PACS, HIS, RIS, EMR, etc., can be provided via the mobile device. The mobile device interface can facilitate real-time collaboration with other end users. Information sharing and recording can be facilitated using multiple media services in real-time or substantially real-time, for example. The mobile device allows the user to focus on patient information and analysis while collaborating with one or more end users without switching or leaving the clinical context being reviewed, as well as exchanging medical data without losing the current state of the clinical context, for example. The mobile device provides a unified communication/collaboration point that can query and access information throughout different information systems, for example.

Certain examples facilitate user authentication via the mobile device. For example, the mobile device can authenticate a user's access to sensitive and/or private information. In certain embodiments, user authentication at the mobile device does not require the user to enter an identifier and password. Instead, the user is known, and the mobile device verifies if the current user is authorized for the particular content/application. Authentication is based on a unique identification number for the device, a connectivity parameter, and a PIN number for the user to enter, for example.

In some examples, a user is provided with an ability to share findings and a walk-through of the findings using a smartphone (e.g., BlackBerry™, iPhone™, etc.) or other handheld device such as an iPod™ or iPad™. Doctors can discuss the findings with the patient by replaying the reading, for example. In some examples, a user is provided with an ability to have a second opinion on the findings from a specialist and/or another radiologist without being in proximity to a workstation. The reading radiologist can contact a specialist for a second opinion and to provide feedback (e.g., commentaries and/or annotations) on the same procedures. The first physician can review and acknowledge or edit (e.g., a document review with tracking changes) the second radiologist's annotation.

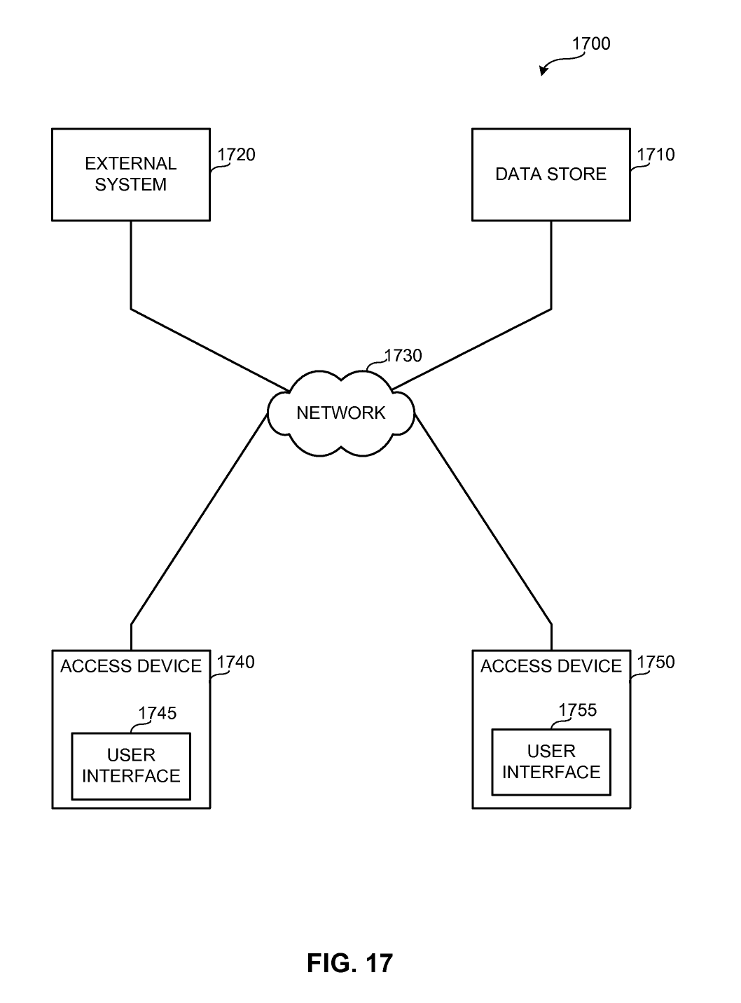

Systems and methods described above can be included in a clinical enterprise system, such as example clinical enterprise system 1700 depicted in FIG. 17. The system 1700 includes a data source 1710, an external system 1720, a network 1730, a first access device 1740 with a first user interface 1745, and a second access device 1750 with a second user interface 1755. In some examples, the data source 1710 and the external system 1720 can be implemented in a single system. In some examples multiple data sources 1710 and/or external systems 1720 can be in communication via the network 1230. The data source 1710 and the external system 1720 can communicate with one or more of the access devices 1740, 1750 via the network 1730. One or more of the access devices 1740, 1750 can communicate with the data source 1710 and/or the external system 1720 via the network 1730. In some examples, the access devices 1740, 1750 can communicate with one another via the network 1730 using a communication interface (e.g., a wired or wireless communications connector/connection (e.g., a card, board, cable, wire, and/or other adapter, such as Ethernet, IEEE 1394, USB, serial port, parallel port, etc.). The network 1730 can be implemented by, for example, the Internet, an intranet, a private network, a wired or wireless Local Area Network, a wired or wireless Wide Area Network, a cellular network, and/or any other suitable network.

The data source 1710 and/or the external system 1720 can provide images, reports, guidelines, best practices and/or other data to the access devices 1740, 1750 for review, options evaluation, and/or other applications. In some examples, the data source 1710 can receive information associated with a session or conference and/or other information from the access devices 1740, 1750. In some examples, the external system 1720 can receive information associated with a session or conference and/or other information from the access devices 1740, 1750. The data source 1710 and/or the external system 1720 can be implemented using a system such as a PACS, RIS, HIS, CVIS, EMR, archive, data warehouse, imaging modality (e.g., x-ray, CT, MR, ultrasound, nuclear imaging, etc.), payer system, provider scheduling system, guideline source, hospital cost data system, and/or other healthcare system.

The access devices 1740, 1750 can be implemented using a workstation (a laptop, a desktop, a tablet computer, etc.) or a mobile device, for example. Some mobile devices include smart phones (e.g., BlackBerry™, iPhone™, etc.), Mobile Internet Devices (MID), personal digital assistants, cellular phones, handheld computers, tablet computers (iPad™), etc., for example. In some examples, security standards, virtual private network access, encryption, etc., can be used to maintain a secure connection between the access devices 1740, 1750, data source 1710, and/or external system 1720 via the network 1730.

The data source 1710 can provide images (e.g., a large image dataset) and/or other data to the access device 1740, 1750. Portions, sub-portions, and/or individual images in a data set can be provided to the access device 1740, 1750 as requested by the access device 1740, 1750, for example. In certain examples, graphical representations (e.g., thumbnails and/or icons) representative of portions, sub-portions, and/or individual images in the data set are provided to the access device 1740, 1750 from the data source 1710 for display to a user in place of the underlying image data until a user requests the underlying image data for review. In some examples, the data source 1710 can also provide and/or receive results, reports, and/or other information to/from the access device 1740, 1750.

The external system 1720 can provide/receive results, reports, and/or other information to/from the access device 1740, 1750, for example. In some examples, the external system 1720 can also provide images and/or other data to the access device 1740, 1750. Portions, sub-portions, and/or individual images in a data set can be provided to the access device 1740, 1750 as requested by the access device 1740, 1750, for example. In certain examples, graphical representations (e.g., thumbnails and/or icons) representative of portions, sub-portions, and/or individual images in the data set are provided to the access device 1740, 1750 from the external system 1720 for display to a user in place of the underlying image data until a user requests the underlying image data for review.

The data source 1710 and/or external system 17230 can be implemented using a system such as a PACS, RIS, HIS, CVIS, EMR, archive, data warehouse, imaging modality (e.g., x-ray, CT, MR, ultrasound, nuclear imaging, etc.).

As discussed above, in some examples, the access device 1740, 1750 can be implemented using a smart phone (e.g., BlackBerry™, iPhone™, iPad™, etc.), Mobile Internet device (MID), personal digital assistant, cellular phone, handheld computer, etc. The access device 1740, 1750 includes a processor retrieving data, executing functionality, and storing data at the access device 1740, 1750, data source 1710, and/or external system 1730. The processor drives a graphical user interface (GUI) 1745, 1755 providing information and functionality to a user and receiving user input to control the device 1740, 1750, edit information, etc. The GUI 1745, 1755 can include a touch pad/screen integrated with and/or attached to the access device 1740, 1750, for example. The device 1740, 1750 includes one or more internal memories and/or other data stores including data and tools. Data storage can include any of a variety of internal and/or external memory, disk, Bluetooth remote storage communicating with the access device 1740, 1750, etc. Using user input received via the GUI 1745, 1755 as well as information and/or functionality from the data and/or tools, the processor can navigate and access images from a large data set and generate one or more reports related to activity at the access device 1740, 1750, for example. Alternatively or in addition to gesture-based navigation/manipulation, a detector, such as an accelerometer, position encoder (e.g., absolute, incremental, optical, analog, digital, etc.), global positioning sensor, and/or other sensor, etc., can be used to detect motion of the access device 1740, 1750 (e.g., shaking, rotating or twisting, left/right turn, forward/backward motion, etc.). Detected motion can be used to affect operation and/or outcomes at the access device 1740, 1750. The access device 1740, 1750 processor can include and/or communicate with a communication interface component to query, retrieve, and/or transmit data to and/or from a remote device, for example.

The access device 1740, 1750 can be configured to follow standards and protocols that mandate a description or identifier for the communicating component (including but not limited to a network device MAC address, a phone number, a GSM phone serial number, an International Mobile Equipment Identifier, and/or other device identifying feature). These identifiers can fulfill a security requirement for device authentication. The identifier is used in combination with a front-end user interface component that leverages an input device such as but not limited to; Personal Identification Number, Keyword, Drawing/Writing a signature (including but not limited to; a textual drawing, drawing a symbol, drawing a pattern, performing a gesture, etc.), etc., to provide a quick, natural, and intuitive method of authentication. Feedback can be provided to the user regarding successful/unsuccessful authentication through display of animation effects on a mobile device user interface. For example, the device can produce a shaking of the screen when user authentication fails. Security standards, virtual private network access, encryption, etc., can be used to maintain a secure connection.

For example, an end user launches a secure application (including but not limited to a clinical application requiring a degree of security). The application reads the unique identifying features of the device and performs an authentication “hand-shake” with the server or data-providing system. This process is automated with no user input or interaction required. After the device has been authenticated, the user is presented with an application/user level authentication screen (including but not limited to a personal identification number (PIN), password/passcode, gesture, etc.) to identify to the application that the user is indeed a valid user. This feature functions as a method to provide device level security as well as an ability to lock the device (e.g., if the user wishes to temporary lock the device but not logout/shutdown the application), for example.

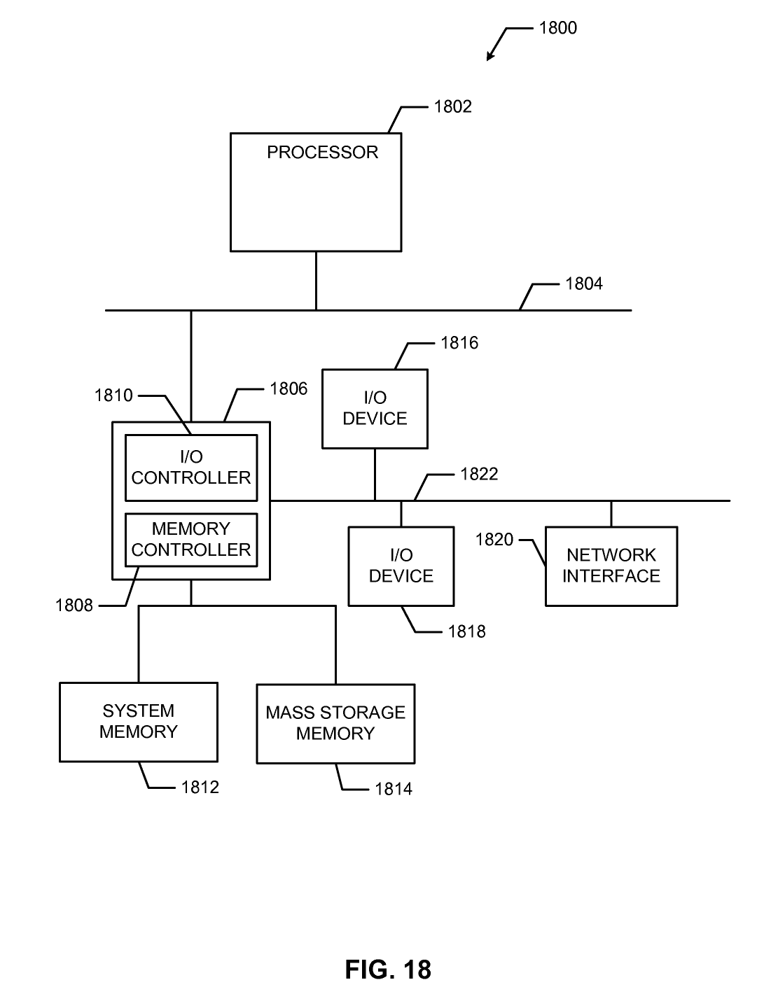

FIG. 18 is a block diagram of an example processor system 1810 that may be used to implement the systems, apparatus and methods described herein. As shown in FIG. 18, the processor system 1810 includes a processor 1812 that is coupled to an interconnection bus 1814. The processor 1812 may be any suitable processor, processing unit or microprocessor. Although not shown in FIG. 18, the system 1810 may be a multi-processor system and, thus, may include one or more additional processors that are identical or similar to the processor 1812 and that are communicatively coupled to the interconnection bus 1814.

The processor 1812 of FIG. 18 is coupled to a chipset 1818, which includes a memory controller 1820 and an input/output (I/O) controller 1822. As is well known, a chipset typically provides I/O and memory management functions as well as a plurality of general purpose and/or special purpose registers, timers, etc. that are accessible or used by one or more processors coupled to the chipset 1818. The memory controller 1820 performs functions that enable the processor 1812 (or processors if there are multiple processors) to access a system memory 1824 and a mass storage memory 1825.

The system memory 1824 may include any desired type of volatile and/or non-volatile memory such as, for example, static random access memory (SRAM), dynamic random access memory (DRAM), flash memory, read-only memory (ROM), etc. The mass storage memory 1825 may include any desired type of mass storage device including hard disk drives, optical drives, tape storage devices, etc.

The I/O controller 1822 performs functions that enable the processor 1812 to communicate with peripheral input/output (I/O) devices 1826 and 1828 and a network interface 1830 via an I/O bus 1832. The I/O devices 1826 and 1828 may be any desired type of I/O device such as, for example, a keyboard, a video display or monitor, a mouse, etc. The network interface 1830 may be, for example, an Ethernet device, an asynchronous transfer mode (ATM) device, an 802.11 device, a DSL modem, a cable modem, a cellular modem, etc. that enables the processor system 1810 to communicate with another processor system.

While the memory controller 1820 and the I/O controller 1822 are depicted in FIG. 18 as separate blocks within the chipset 1818, the functions performed by these blocks may be integrated within a single semiconductor circuit or may be implemented using two or more separate integrated circuits.

Thus, certain examples provide systems and methods for display and navigation of large image data sets. Certain examples provide a technical effect of a thumbnail or icon view of portions of the large data set to facilitate a single user view and navigation via a handheld and/or other mobile device, where image data is loaded for display when the user selects a specific image.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN), a wide area network (WAN), a wireless network, a cellular phone network, etc., that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method for navigating images in a large data set using a mobile device having a user interface, said method comprising:
providing a clinical data set for user view, the clinical data set divided into a plurality of portions, each portion associated with a graphical representation and including a plurality of sub-portions, wherein the graphical representation for each portion is displayed to a user such that the plurality of portions can be viewed on a user interface of a mobile device according to their graphical representations without downloading content of each portion to the mobile device;
facilitating user navigation at various levels of granularity among the plurality of portions via the user interface of the mobile device;
allowing user access to one or more sub-portions within a portion to locate an item of clinical data within a sub-portion;
enabling user selection of an item of clinical data within a sub-portion for viewing via the user interface of the mobile device; and
loading a selected item of clinical data for viewing via the user interface of the mobile device.

2. The method of claim 1, wherein user navigation comprises a gesture made by a user on a touch screen of the user interface of the mobile device.

3. The method of claim 1, wherein the graphical representation comprises at least one of an image thumbnail and an icon associated with the portion of the clinical data set.

4. The method of claim 3, wherein the image thumbnail comprises a thumbnail of an image taken from the middle of the portion of the clinical data set.

5. The method of claim 1, upon a zoom user navigation, a selected portion is enlarged and repositioned within the user interface along with surrounding portions.

6. The method of claim 1, wherein, once the user has navigated to a lowest level of available detail, individual objects defining a portion are transferred from an external data store to the mobile device.

7. The method of claim 1, further comprising visually indicating a progress of data loading to a local memory on the mobile device.

8. The method of claim 1, wherein the clinical data set comprises a plurality of clinical images and wherein the selected item of clinical data comprises a selected image.

9. A tangible computer-readable storage medium having a set of instructions stored thereon which, when executed, instruct a processor to implement a method for navigating clinical content in a large data set using a mobile device having a user interface, the method comprising:
providing a clinical data set for user view, the clinical data set divided into a plurality of portions, each portion associated with a graphical representation and including a plurality of sub-portions, wherein the graphical representation for each portion is displayed to a user such that the plurality of portions can be viewed on a user interface of a mobile device according to their graphical representations without downloading content of each portion to the mobile device;
facilitating user navigation at various levels of granularity among the plurality of portions via the user interface of the mobile device;
allowing user access to one or more sub-portions within a portion to locate an item of clinical data within a sub-portion;
enabling user selection of an item of clinical data within a sub-portion for viewing via the user interface of the mobile device; and
loading a selected item of clinical data for viewing via the user interface of the mobile device.

10. The tangible computer-readable storage medium of claim 9, wherein user navigation comprises a gesture made by a user on a touch screen of the user interface of the mobile device.

11. The tangible computer-readable storage medium of claim 9, wherein the graphical representation comprises at least one of an image thumbnail and an icon associated with the portion of the clinical data set.

12. The tangible computer-readable storage medium of claim 11, wherein the image thumbnail comprises a thumbnail of an image taken from the middle of the portion of the clinical data set.

13. The tangible computer-readable storage medium of claim 9, upon a zoom user navigation, a selected portion is enlarged and repositioned within the user interface along with surrounding portions.

14. The tangible computer-readable storage medium of claim 9, wherein, once the user has navigated to a lowest level of available detail, individual objects defining a portion are transferred from an external data store to the mobile device.

15. The tangible computer-readable storage medium of claim 9, further comprising visually indicating a progress of data loading to a local memory on the mobile device.

16. The tangible computer-readable storage medium of claim 9, wherein the clinical data set comprises a plurality of clinical images and wherein the selected item of clinical data comprises a selected image.

17. An image viewing and navigation system comprising:
a handheld device including a memory, a processor, a user interface including a display, and a communication interface, the handheld device configured to communicate with an external data source to retrieve and display image data from an image data set, the handheld device facilitating user navigation and review of images from the image data set via the user interface,
wherein the processor executes instructions saved on the memory to:
provide access to an image data set stored at the external data source, the image data set divided into a plurality of portions, each portion associated with a graphical representation and including a plurality of sub-portions, wherein the graphical representation for each portion is displayed to a user such that the image data set divided into the plurality of portions can be viewed via the user interface according to their graphical representations without downloading content of each portion to the mobile device;
facilitate user navigation at various levels of granularity among the plurality of portions via the user interface;
allow user access to one or more sub-portions within a portion to locate an image within a sub-portion;
enable user selection of an image within a sub-portion for viewing via the user interface; and
load a selected image from the external data source via the communication interface for viewing via the user interface.

18. The system of claim 17, wherein user navigation comprises a gesture made by a user on a touch screen of the user interface.

19. The system of claim 17, wherein the graphical representation comprises at least one of an image thumbnail and an icon associated with the portion of the image data set.

20. The system of claim 19, wherein the image thumbnail comprises a thumbnail of an image taken from the middle of the portion of the image data set.

21. The system of claim 17, upon a zoom user navigation, a selected portion is enlarged and repositioned within the user interface along with surrounding portions.

22. The system of claim 17, wherein, once the user has navigated to a lowest level of available detail, individual objects defining a portion are transferred from an external data store to the memory of the handheld device.
